(19) United States
(12) Patent Application Publication
(10) Pub. No.: US 2026/0244741 A1
(43) Pub. Date: Aug. 20, 2026

(54) INFORMATION HANDLING SYSTEM WITH FIRMWARE INTERFACE PROTECTION

(71) Applicant: DELL PRODUCTS L.P., Round Rock, TX (US)

(72) Inventors: Venkata Rama Krishna Rao Atta, Hyderabad (IN); Ibrahim Sayyed, Georgetown, TX (US); Adolfo Montero, Pflugerville, TX (US)

(21) Appl. No.: 19/059,089

(22) Filed: Feb. 20, 2025

(51) Int. Cl. G06F 21/55

(52) U.S. Cl. CPC G06F 21/554; G06F 2221/034

(57) ABSTRACT

An information handling system may include a memory that includes an intrusion detection service module, an intrusion scan service module, or a combination thereof, and a processor operably coupled to the memory. The processor determines whether an intrusion into the information handling system occurred using the intrusion detection service module. The processor also polls one or more hardware components, applications, security settings, or a combination thereof, when an intrusion is detected using the intrusion scan service module.

### FIELD OF THE DISCLOSURE

The present disclosure generally relates to information handling systems, and more particularly relates to monitoring hardware changes in an information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system may include a memory that includes an intrusion detection service module, an intrusion scan service module, or a combination thereof, and a processor operably coupled to the memory. The processor may determine whether an intrusion into the information handling system occurred using the intrusion detection service module. The processor also may poll one or more hardware components, applications, security settings, or a combination thereof, when an intrusion is detected using the intrusion scan service module.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system according to an embodiment of the present disclosure;

FIG. 2 is a block diagram of another information handling system according to an embodiment of the present disclosure;

FIG. 3 is a first portion of a flow diagram of a method for protecting firmware interfaces after changes in hardware configuration according to an embodiment of the present disclosure;

FIG. 4 is a second portion of a flow diagram of a method for protecting firmware interfaces after changes in hardware configuration according to an embodiment of the present disclosure; and

FIG. 5 is a block diagram of still another information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

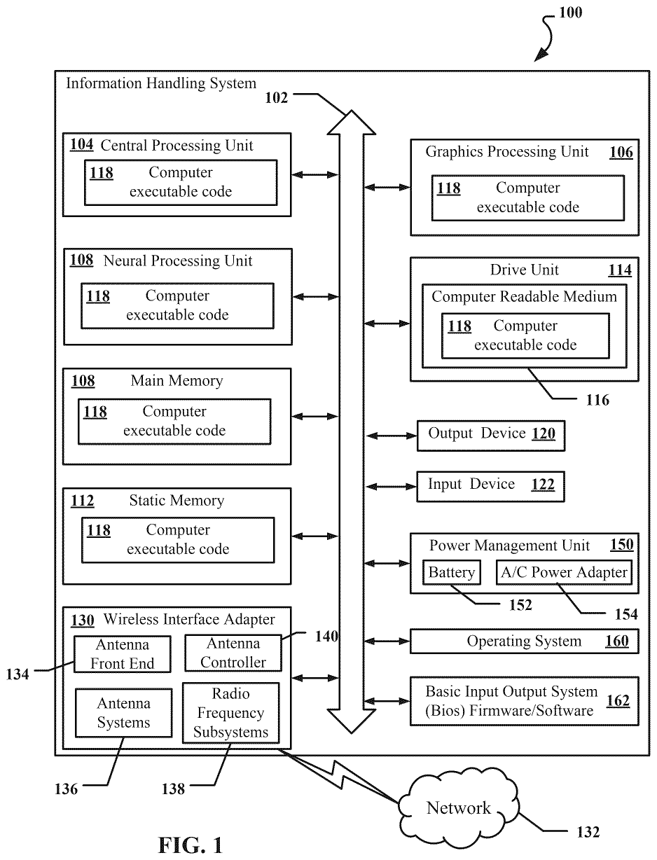

FIG. 1 illustrates an information handling system 100 having various components disposed therein. For purposes of this disclosure, the information handling system 100 may include any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, the information handling system 100 can be a personal computer, a mobile device (e.g., a personal digital assistant (PDA) or a smart phone), server (e.g., a blade server or a rack server), a consumer electronic information handling system, a network server or storage device, a network router, switch, or bridge, wireless router, or other network communication information handling system, a network connected device (cellular telephone, tablet information handling system, etc.), IoT computing device, wearable computing device (e.g., a smart watch or smart glasses), a set-top box (STB), a mobile device, a palmtop computer, a laptop computer, a desktop computer, a communications device, an access point (AP), a base station transceiver, a wireless telephone, a land-line telephone, a control system, a camera, a scanner, a facsimile machine, a printer, a pager, a personal device, a web appliance, or any other suitable machine capable of executing a set of instructions (sequential or otherwise) that specify actions to be taken by that machine, and can vary in size, shape, performance, price, and functionality.

In a networked deployment, for example, the information handling system 100 may operate in the capacity of a server or as a client computer in a server-client network environment, or as a peer computer system in a peer-to-peer (or distributed) network environment. In a particular embodiment, the information handling system 100 can be implemented using electronic information handling systems that provide voice, video or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or multiple sets, of instructions to perform one or more computer functions.

In general, the information handling system 100 can include memory (volatile (e.g., random-access memory, etc.), nonvolatile (read-only memory, flash memory etc.) or any combination thereof), one or more processing resources, such as a central processing unit (CPU), a graphics processing unit (GPU), a neural processing unit (NPU), hardware or software control logic, or any combination thereof. Additional components of the information handling system 100 can include one or more storage devices, one or more communications ports for communicating with external devices, as well as, various input and output (I/O) devices, such as a keyboard, a mouse, a video/graphic display, or any combination thereof. The information handling system 100 can also include one or more buses operable to transmit communications between the various hardware components. Portions of an information handling system 100 may themselves be considered information handling systems 100. The information handling system 100 can include devices or modules that embody one or more of the devices or execute instructions for the one or more systems and modules described herein, and operates to perform one or more of the methods described herein.

As illustrated in FIG. 1, in particular, the information handling system 100 can include one or more buses 102 operable to transmit communications between the various hardware components such as any combination of various input and output (I/O) devices described herein. The information handling system 100 can include one or more processors operably coupled to the bus 102. For example, the information handling system 100 can include a central processing unit (CPU) 104, a graphics processing unit (GPU) 106, a neural processing unit (NPU) 108, or any combination thereof. The CPU 104, the GPU 106, and the NPU 108 may include control logic and may individually, or collectively, operate to execute code that is either firmware or software code. Moreover, the information handling system 100 can include one or more memory devices such as a main memory 110, a static memory 112, and a drive unit 114 having a computer readable medium 116 disposed therein. The drive unit 114 can include a hard drive unit, a solid state drive unit, or a combination thereof. Further, the various memory devices 110, 112, 114, 116 may include volatile memory (e.g., random-access memory, etc.), nonvolatile memory (read-only memory, flash memory etc.) or any combination thereof).

The information handling system 100 includes computer executable code 118 that may reside on, or be executed by, the CPU 104, the GPU 106, the NPU 108, the main memory 110, the static memory 112, the computer readable medium 116 of the drive unit 114, or any combination thereof. The computer executable code 118 can include instructions (e.g., software algorithms), parameters, and profiles. The computer executable code 118 that may operate on servers or systems, remote data centers, or on-box in individual client information handling systems according to various embodiments herein. In some embodiments, it is understood any or all portions of the computer executable code 118 may operate on, or be executed by, the CPU 104, the GPU 106, the NPU 108, the main memory 110, the static memory 112, the computer readable medium 116 of the drive unit 114, or any combination thereof. In some embodiments, it is understood any or all portions of computer executable code 118 may operate on a plurality of information handling systems 100.

As shown, the information handling system 100 may further include an output device 120, e.g., a video display output. In an embodiment, the output device 120 may include a liquid crystal display (LCD), an organic light emitting diode (OLED), a flat panel display, a solid-state display, a curved panel display, a flexible panel display, or a combination thereof. Further, the output device 120 may include one or more sound output devices, e.g., speakers. As further illustrated, the information handling system 100 may include an input device 122 that may include an alpha numeric input device, such as a keyboard, and/or a cursor control device, such as a mouse, touchpad, or gesture or touch screen input device.

The information handling system 100 may also include a network interface device, shown as a wireless interface adapter 130, that can provide connectivity to a network 132, e.g., a wide area network (WAN), a local area network (LAN), wireless local area network (WLAN), a wireless personal area network (WPAN), a wireless wide area network (WWAN), or another network. In an embodiment, the WAN, WWAN, LAN, and WLAN may each include an access point used to operatively coupled the information handling system 100 to a network. In a specific embodiment, the network 154 may include macro-cellular connections via one or more base stations, one or more wireless access points (e.g., Wi-Fi or WiGig), one or more licensed or unlicensed WWAN small cell base stations, or a combination thereof. Further, network connectivity may be a wired or wireless connection.

As depicted, the wireless interface adapter 130 may include an antenna front end 134, one or more antenna systems 136, one or more radio frequency subsystems 138, and an antenna controller 140. These components may include transmitter/receiver circuitry, modem circuitry, one or more radio frequency front end circuits, one or more wireless controller circuits, amplifiers, and other circuitry of the wireless interface adapter, such as one or more antenna ports used for wireless communications via multiple radio access technologies. Each radio frequency subsystem 134 may communicate with one or more wireless technology protocols. The radio frequency subsystem 134 may contain individual subscriber identity module (SIM) profiles for each technology service provider and their available protocols for any operating subscriber-based radio access technologies such as cellular LTE communications.

In some embodiments of the present disclosure, the wireless interface adapter 130 may operate two or more wireless links. In a further embodiment, the wireless interface adapter 130 may operate the two or more wireless links with a single, shared communication frequency band such as with the 5G standard relating to unlicensed wireless spectrum for small cell 5G operation or for unlicensed Wi-Fi WLAN operation in an example embodiment. For example, a 1.4 GHz/2.5 GHz or 5 GHz wireless communication frequency bands may be apportioned under the 5G standards for communication on either small cell WWAN wireless link operation or Wi-Fi WLAN operation. In some embodiments, the shared, wireless communication band may be transmitted through one or a plurality of antennas or antennas may be capable of operating at a variety of frequency bands.

The wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP 2, or similar wireless standards may be used. Wireless interface adapter 130 may connect to any combination of macro-cellular wireless connections including 2G, 2.5G, 3G, 4G, 5G or the like from one or more service providers. Utilization of radiofrequency communication bands according to several example embodiments of the present disclosure may include bands used with the WLAN standards and WWAN carriers which may operate in both licensed and unlicensed spectrums. For example, both WLAN and WWAN may use the Unlicensed National Information Infrastructure (U-NII) band which typically operates in the ~5 MHz frequency band such as 802.11a/h/j/n/ac/ax (e.g., center frequencies between 5.170-7.125 GHz). WLAN, for example, may operate at a 2.4 GHz band, 5 GHz band, and/or a 6 GHz band according to, for example, Wi-Fi, Wi-Fi 6, or Wi-Fi 6E standards. WWAN may operate in a number of bands, some of which are proprietary but may include a wireless communication frequency band. For example, low-band 5G may operate at frequencies similar to 4G standards at 600-850 MHz. Mid-band 5G may operate at frequencies between 2.5 and 3.7 GHz. Additionally, high-band 5G frequencies may operate at 25 to 39 GHz and even higher. In additional examples, WWAN carrier licensed bands may operate at the new radio frequency range 2 (NRFR1), NFRF2, bands, and other known bands. Each of these frequencies used to communicate over the network 254 may be based on the radio access network (RAN) standards that implement, for example, eNodeB or gNodeB hardware connected to mobile phone networks (e.g., cellular networks) used to communicate with the information handling system 200. In the example embodiment, mobile device 200 may also include both unlicensed wireless RF communication capabilities as well as licensed wireless RF communication capabilities. For example, licensed wireless RF communication capabilities may be available via a subscriber carrier wireless service operating the cellular networks. With the licensed wireless RF communication capability, a WWAN RF front end of the information handling system 100 may operate on a licensed WWAN wireless radio with authorization for subscriber access to a wireless service provider on a carrier licensed frequency band.

The wireless interface adapter 130 can represent an add-in card, wireless network interface module that is integrated with a main board of the information handling system or integrated with another wireless network interface capability, or any combination thereof. In an embodiment the wireless interface adapter 130 may include one or more radio frequency subsystems 130 including transmitters and wireless controllers for connecting via a multitude of wireless links. In an example embodiment, an information handling system may have an antenna system transmitter for 5G small cell WWAN, Wi-Fi WLAN or WiGig connectivity and one or more additional antenna system transmitters for macro-cellular communication. The radio frequency subsystems 130 include wireless controllers to manage authentication, connectivity, communications, power levels for transmission, buffering, error correction, baseband processing, and other functions of the wireless interface adapter 130.

The information handling system 100 may further include a power management unit (PMU) 150 (a.k.a. a power supply unit (PSU)). The PMU 150 may manage the power provided to the components of the information handling system 100, e.g., the CPU 104, the GPU 106, the NPU 108, the main memory 110, the static memory 112, the drive unit 114, the output device 120, the input device 122, the wireless interface adapter 130, any combination thereof, and any other components that may require power when a power button on the information handling system 100 is actuated by a user. In an embodiment, the PMU 150 may monitor power levels and be electrically coupled to the information handling system 100 to provide this power and coupled to bus 108 to provide or receive data or instructions. The PMU 150 may regulate power from a power source such as a battery 152 or A/C power adapter 154. In an embodiment, the battery 152 may be charged via the A/C power adapter 154 and provide power to the components of the information handling system 100 when A/C power from the A/C power adapter 154 is removed.

FIG. 1 further indicates that the information handling system 100 includes an operating system (OS) 160, a basic input/output system (BIOS) firmware/software 162, one or more application programs, or a combination thereof that may be part of the computer executable code 118 that is executed at the CPU 104, the GPU 106, the NPU 108, or a combination thereof, and stored the main memory 110, the static memory 112, the computer readable medium 116 of the drive unit 114, or any combination thereof. The BIOS firmware/software 162 functions to initialize information handling system 100 on power up, to launch the OS 160, and to manage input and output interactions between the OS 160 and the other elements of information handling system 100. In a particular embodiment, BIOS firmware/software 162 resides in the main memory 108 or the static memory 112, and includes machine-executable code that is executed by the CPU 104 to perform various functions of information handling system 100 as described herein. In another embodiment (not illustrated), application programs and BIOS firmware/software 162 can reside in another storage medium of information handling system 100. For example, application programs and BIOS firmware/software 162 can reside in the drive unit 114, in a ROM (not illustrated) associated with information handling system 100, in an option-ROM (not illustrated) associated with various devices of information handling system 100, in a storage system (not illustrated) associated with network channel of the wireless interface adapter 130, in another storage medium of information handling system 100, or a combination thereof. It is to be understood that computer executable code 118 for application programs and BIOS firmware/software 138 can each be implemented as single programs, or as separate programs carrying out the various features as described herein.

As stated above, the information handling system 100 may connect to the external wireless network 132. In particular, the wireless network 132 may have a wireless mesh architecture in accordance with mesh networks described by the wireless data communications standards or similar standards in some embodiments but not necessarily in all embodiments. The wireless interface adapter 130 may connect to the external wireless network 133 via a WPAN, WLAN, WWAN or similar wireless switched Ethernet connection in some embodiments. The wireless data communication standards set forth protocols for communications and routing via access points, as well as protocols for a variety of other operations. Other operations may include handoff of client devices moving between nodes, self-organizing of routing operations, or self-healing architectures in case of interruption.

In some embodiments, software, firmware, dedicated hardware implementations such as application specific integrated circuits, programmable logic arrays and other hardware information handling systems can be constructed to implement one or more of the methods described herein. Applications that may include the apparatus and systems of various embodiments can broadly include a variety of electronic and computer systems. One or more embodiments described herein may implement functions using two or more specific interconnected hardware modules or information handling systems with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a controller or a processor system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 116 that includes computer executable code 118 (e.g., instructions, parameters, and profiles), or receives and executes computer executable code 118 (e.g., instructions, parameters, and profiles) responsive to a propagated signal; so that a device connected to the wireless network 132 can communicate voice, video or data over the wireless network 132. Further, the computer executable code 118 may be transmitted or received over the wireless network 132 via the network interface device, i.e., the wireless interface adapter 130.

The wireless interface adapter 130 represents a network interface card (NIC) disposed within information handling system 100, on a main circuit board of the information handling system 100, integrated onto another component such as the CPU 104, in another suitable location, or a combination thereof. The wireless interface adapter 130 can include another information handling system, a data storage system, another network, a grid management system, another suitable resource, or a combination thereof. In an embodiment, the wireless interface adapter 130 may operably connect to the network 132. The connection to network 132 may be wired or wireless.

The network interface device shown as wireless interface adapter 130 can provide connectivity to the network 132, such as a wide area network (WAN), a local area network (LAN), wireless local area network (WLAN), a wireless personal area network (WPAN), a wireless wide area network (WWAN), or another network. Connectivity may be via wired or wireless connection. The wireless interface adapter 130 may include an adaptive massive MIMO Multiplexer with transmitter/receiver circuitry, wireless controller circuitry, amplifiers and other circuitry for wireless communications. The wireless interface adapter 130 may also include antenna systems 136 as described above which may be tunable antenna systems for use with the system and methods disclosed in the embodiments herein. The antenna controller 140 may also include wireless controllers to manage authentication, connectivity, communications, power levels for transmission, buffering, error correction, baseband processing, and other functions of the wireless interface adapter 130.

The information handling system 100 can include a set of computer executable code 118 that can be executed to cause the information handling system 100 to perform any one or more of the methods or computer-based functions disclosed herein. For example, computer executable code 118 may execute an email algorithm, various software applications, software agents, or other aspects or components. Various software modules comprising application computer executable code 118 may be coordinated by the OS 160, and/or via an application programming interface (API). An example operating system may include Windows®, Android®, and other OS types known in the art. Example APIs may include Win 32, Core Java API, or Android APIs.

The drive unit 114 may include a computer-readable medium 116 in which one or more sets of computer executable code 118 such as software can be embedded to be executed by the CPU 104, the GPU 106, the NPU 108, or a combination thereof, to perform the processes described herein. Similarly, main memory 104 and static memory 106 may also contain a computer-readable medium for storage of one or more sets computer executable code 118 (e.g., instructions, parameters, or profiles) including an email program. The drive unit 114 or static memory 112 also contain space for data storage. Further, the computer executable code 118 may embody one or more of the methods or logic as described herein. In a particular embodiment, the computer executable code 118 may reside completely, or at least partially, within the main memory 104, the static memory 106, and/or within the disk drive 116 during execution by the CPU 104 of the information handling system 100. The CPU 104, the GPU 106, and the NPU 108 also may include computer-readable media.

The main memory 108, the static memory 112, or other memory of the embodiments described herein may contain computer-readable medium (not shown), such as RAM. An example of main memory 108 can include random access memory (RAM) such as static RAM (SRAM), dynamic RAM (DRAM), non-volatile RAM (NV-RAM), or the like, read only memory (ROM), another type of memory, or a combination thereof. The static memory 112 may contain computer-readable medium (not shown), such as NOR or NAND flash memory in some example embodiments. The drive unit 114 may include access to a computer-readable medium 116 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In other embodiments, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

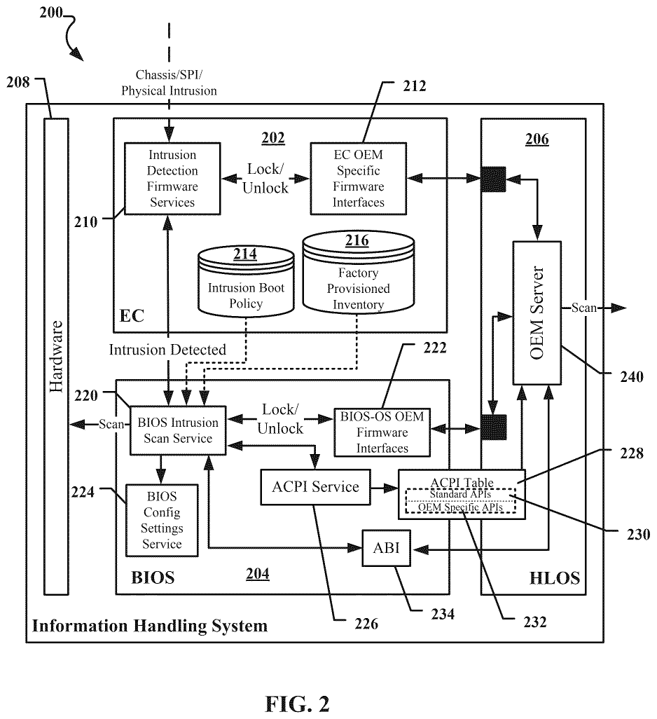

Referring now to FIG. 2, another information handling system is illustrated and is generally designated 200. As shown, the information handling system 200 includes an embedded controller 202 (EC) that communicates with a basic input output system (BIOS) 204 and a high level operating system (HLOS) 206. The information handling system 200 further includes one or more hardware devices 208. The one or more hardware devices 208 may include internal or external hardware devices such as, a central processing unit (CPU), a random access memory (RAM), a motherboard, a computer data storage, a graphics card, a sound card, a computer case, a monitor, a mouse, a keyboard, speakers, or any combination thereof.

As shown, the EC 202 includes an intrusion detection firmware services module 210 and an EC original equipment manufacturer (OEM) specific firmware services module 212 operably coupled thereto. The EC 202 further includes an intrusion boot policy database 214 and a factory provisioned inventory database 216. The BIOS 204 includes a BIOS intrusion scan service module 220 operably coupled to the intrusion detection firmware services module 210 within the EC 202. The BIOS intrusion scan service module 220 is also operably coupled to the intrusion boot policy database 214 and the factory provisioned inventory database 216 within the EC 202. The BIOS intrusion scan service module 220 is configured to scan the one or more hardware devices 208 upon startup to confirm the one or more hardware devices 208 are authorized and no unauthorized hardware devices are installed in the information handling system 200 while the information handling system 200 is powered off or in a sleep state.

FIG. 2 shows that the BIOS 204 also includes a BIOS-OS OEM firmware interfaces module 222 operably coupled to the BIOS intrusion scan service module 220. Further, the BIOS includes BIOS configuration settings service module 224 operably coupled to the BIOS intrusion scan service module 220. The BIOS 204 further includes an advanced configuration and power interface (ACPI) module 226 that is operably coupled to the BIOS intrusion scan service module 220 and an ACPI table 228. The ACPI table 228 includes one or more standard application programming interfaces (API) 230 and one or more OEM specific APIs 232. The BIOS 204 also includes an application binary interface (ABI) 234 that is operably coupled to the BIOS intrusion scan service module 220.

As further illustrated in FIG. 2, the HLOS 206 includes an OEM server module 240 that is operably coupled to the EC OEM specific firmware interfaces module 212 within the EC 202. The OEM server module 240 is also operably coupled to the BIOS-OS OEM firmware interfaces module 222 within the BIOS 204. The OEM server module 240 within the HLOS is also operably coupled to the ACPI Table 228 of the BIOS 204 and the ABI 234.

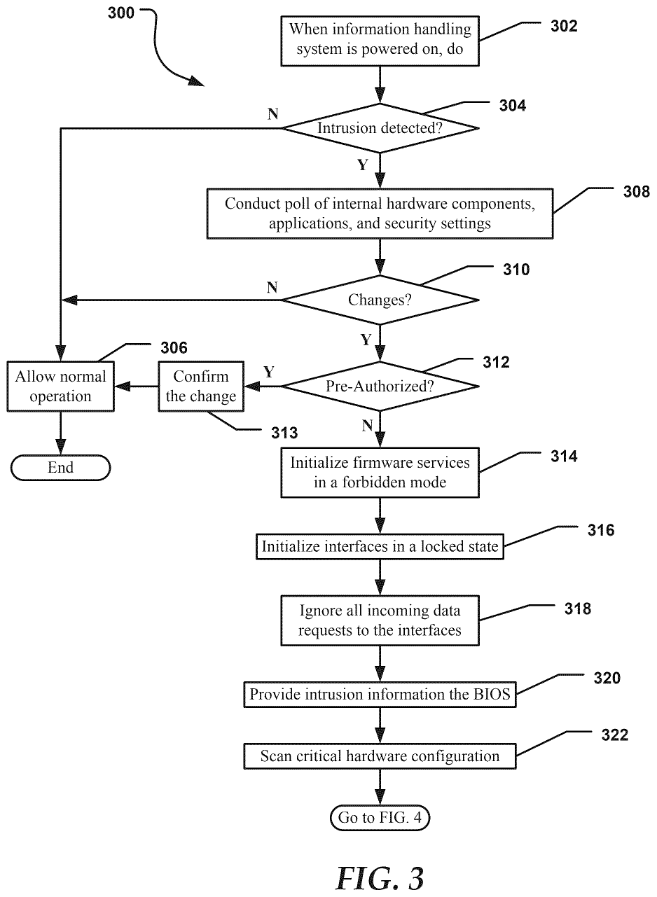

FIG. 3 illustrates a flow diagram of a method 300 a method for protecting firmware interfaces after changes in hardware configuration within an information handling system. For example, the information handling system is configured according to at least one embodiment of the present disclosure and the method 300 commences at block 302. It will be readily appreciated that not every method step set forth in this flow diagram is always necessary, and that certain steps of the methods may be combined, performed simultaneously, in a different order, or perhaps omitted, without varying from the scope of the disclosure. The method steps depicted in FIG. 3 may be executed, or employed in whole, or in part, by any of the processors disclosed herein, any other type of controller, device, module, processor, or any combination thereof, operable to employ, or otherwise execute, all, or portions of, the method 300 of FIG. 3.

Beginning at block 302, the method 300 includes entering a do loop wherein when information handling system is powered on the following steps are performed. For example, at decision step 304, the method 300 includes determining whether an intrusion is detected. For example, an intrusion can occur while the information handling system is asleep and may include a physical intrusion in which a user opens the chassis, or housing, of the information handling system. The intrusion may also be an electronic intrusion in which forced communication with the information handling system occurs via a serial peripheral interface (SPI). For example, the intrusion may be detected by the intrusion detection firmware service module 210 within the embedded controller 202.

At decision 304, if no intrusion is detected, the method 300 proceeds to block 306 and the method 300 includes allowing normal operation of the information handling system 300 in which full access is provided to the ACPI table 228 and the standard APIs 230 and OEM specific APIs 232. Thereafter, the method 300 ends.

Conversely, at decision step 304 if an intrusion is detected, the method 300 proceeds to block 308. At block 308, the method 300 includes conducting a poll of internal hardware components, applications, and security settings. Thereafter, at decision 310, the method 300 includes determining whether any changes to the hardware components, applications, and/or security settings have occurred. For example, a change occurs when a new hardware component is installed, when a new application is added, or if a security change has occurred to facilitate installation of the new hardware or new application. If no changes have occurred, the method 300 moves to block 306 and the method 300 includes allowing normal operation and providing full access to the ACPI table and the standard APIs and OEM specific APIs. Thereafter, the method 300 may end.

Returning to decision 310, if changes are detected, the method 300 may proceed to decision step 312 and the method 300 may include determining whether the change, or changes, were authorized, or pre-authorized. An example of an authorized, or pre-authorized, change may including swapping a particular OEM hardware component for another OEM hardware component (e.g., upgrading a non-volatile memory). If the detected change is indeed pre-authorized, the method 300 may continue to block 313 and the method 300 includes confirming the change. Then, the method 300 can move to block 306 and the method 300 may include allowing normal operation and providing full access to the ACPI table and the standard APIs and OEM specific APIs. Thereafter, the method 300 may end.

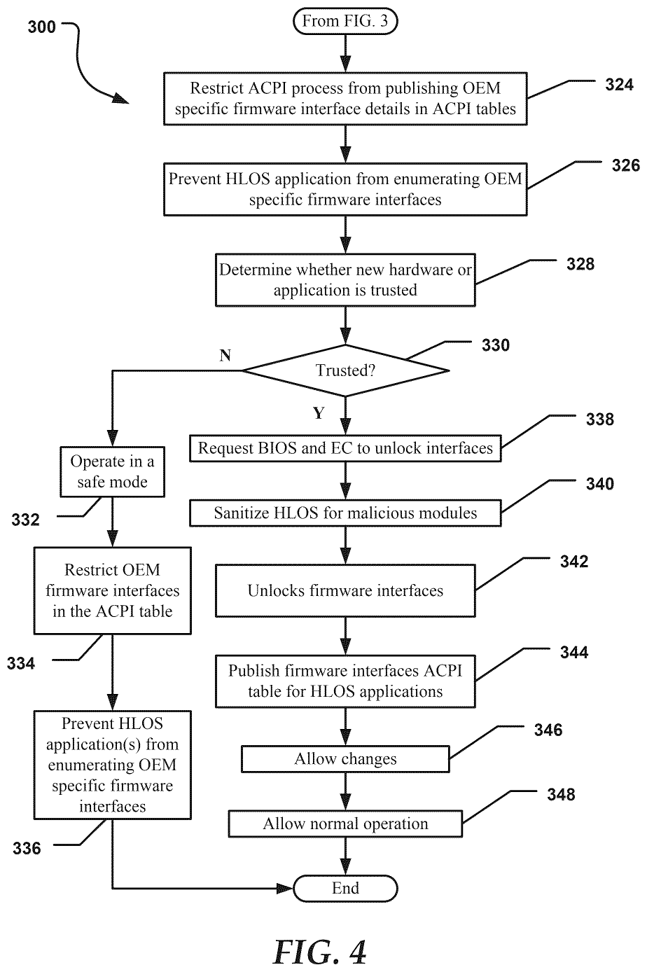

If the change, or changes, are not authorized, or pre-authorized, (i.e., unauthorized) the method 300 may move to block 314 and the method 300 includes blocking one or more boot resources available to the new hardware component or application. For example, the method 300 may include initializing one or firmware services in a forbidden mode. Then, at block 316, the method 300 may include initializing one or more interfaces in a locked state. Further, at block 318, the method 300 may include ignoring all incoming data requests to the interfaces. At block 320, the method 300 includes providing intrusion information to the BIOS. Thereafter, at block 322, the method 300 includes scanning critical hardware configurations. The method 300 then proceeds to block 324 of FIG. 4.

At block 324, the method 300 includes restricting ACPI process from publishing OEM specific firmware interface details in ACPI tables. Further, at block 326, the method 300 may include prevent one or more HLOS applications from enumerating OEM specific firmware interfaces. Moving to block 328, the method 300 may include determining whether the unauthorized change, e.g., the new hardware, or application, is trusted. If the new hardware or application is not trusted, the method 300 may proceed to block 332 and the method 300 includes operating in a safe mode. Then, at block 334, the method 300 may include restricting OEM firmware interfaces in the ACPI table. At block 336, the method 300 may include preventing one or more HLOS application from enumerating OEM specific firmware interfaces. Thereafter, the method 300 may end.

Returning to decision step 330, if the unauthorized change, i.e., the new hardware or application, is trusted, the method 300 may proceed to block 338 where the method 300 includes requesting BIOS and EC to unlock interfaces. At block 340, the method 300 includes sanitizing the HLOS for malicious modules. Then, at block 342, the method 300 includes unlocking the firmware interfaces. At block 344, the method includes publishing the firmware interfaces ACPI table for HLOS applications. Proceeding to block 346, the method 300 includes allowing the hardware or application change(s). Thereafter, at block 348, the method includes allowing normal operation and providing full access to the ACPI table and the standard APIs and OEM specific APIs. The method then ends.

Accordingly, when the method 300 is executed the information handling system boots to an intrusion state when unauthorized hardware is detected, when unauthorized software is detected, or when unauthorized security changes are detected. In the intrusion state, instead of exposing critical service applications that interface with the EC/BIOS for instrumentation and control data, the method 300 restriction HLOS service applications to limited, or no functionality, until the intrusion is resolved, or removed.

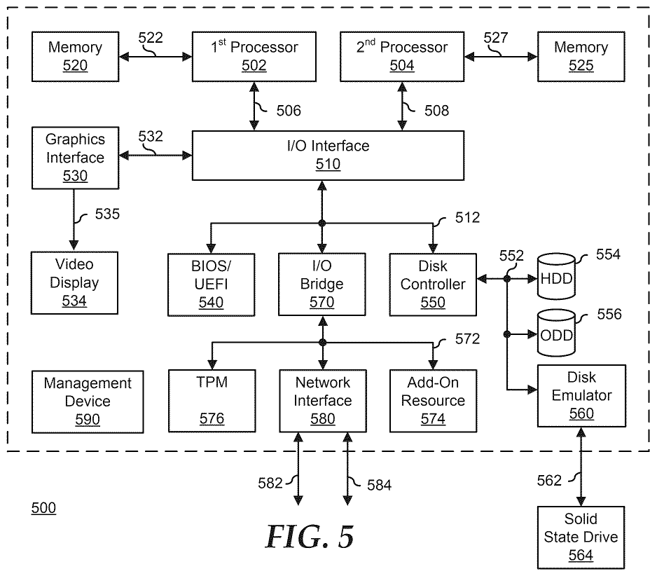

FIG. 5 shows a generalized embodiment of an information handling system 500 according to an embodiment of the present disclosure. Information handling system 500 may be substantially similar to the information handling system 100 of FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 500 can include processing resources for executing machine-executable code, such as a central processing unit (CPU), a programmable logic array (PLA), an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described below and operates to perform one or more of the methods described herein. Information handling system 500 includes a processors 502 and 504, an input/output (I/O) interface 510, memories 520 and 525, a graphics interface 530, a basic input and output system/universal extensible firmware interface (BIOS/UEFI) module 540, a disk controller 550, a hard disk drive (HDD) 554, an optical disk drive (ODD) 556, a disk emulator 560 connected to an external solid state drive (SSD) 564, an I/O bridge 570, one or more add-on resources 574, a trusted platform module (TPM) 576, a network interface 580, a management device 590, and a power supply 595. Processors 502 and 504, I/O interface 510, memory 520, graphics interface 530, BIOS/UEFI module 540, disk controller 550, HDD 554, ODD 556, disk emulator 560, SSD 564, I/O bridge 570, add-on resources 574, TPM 576, and network interface 580 operate together to provide a host environment of information handling system 500 that operates to provide the data processing functionality of the information handling system. The host environment operates to execute machine-executable code, including platform BIOS/UEFI code, device firmware, operating system code, applications, programs, and the like, to perform the data processing tasks associated with information handling system 500.

In the host environment, processor 502 is connected to I/O interface 510 via processor interface 506, and processor 504 is connected to the I/O interface via processor interface 508. Memory 520 is connected to processor 502 via a memory interface 522. Memory 525 is connected to processor 504 via a memory interface 527. Graphics interface 530 is connected to I/O interface 510 via a graphics interface 532 and provides a video display output 536 to a video display 534. In a particular embodiment, information handling system 500 includes separate memories that are dedicated to each of processors 502 and 504 via separate memory interfaces. An example of memories 520 and 525 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 540, disk controller 550, and I/O bridge 570 are connected to I/O interface 510 via an I/O channel 512. An example of I/O channel 512 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 510 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 540 includes BIOS/UEFI code operable to detect resources within information handling system 500, to provide drivers for the resources, initialize the resources, and access the resources. BIOS/UEFI module 540 includes code that operates to detect resources within information handling system 500, to provide drivers for the resources, to initialize the resources, and to access the resources.

Disk controller 550 includes a disk interface 552 that connects the disk controller to HDD 554, to ODD 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an IEEE 5394 (Firewire) interface, a proprietary interface, or a combination thereof. Alternatively, solid-state drive 564 can be disposed within information handling system 500.

I/O bridge 570 includes a peripheral interface 572 that connects the I/O bridge to add-on resource 574, to TPM 576, and to network interface 580. Peripheral interface 572 can be the same type of interface as I/O channel 512 or can be a different type of interface. As such, I/O bridge 570 extends the capacity of I/O channel 512 when peripheral interface 572 and the I/O channel are of the same type, and the I/O bridge translates information from a format suitable to the I/O channel to a format suitable to the peripheral channel 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as I/O interface 510, in another suitable location, or a combination thereof. Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Management device 590 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 500. In particular, management device 590 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 500, such as system cooling fans and power supplies. Management device 590 can include a network connection to an external management system, and the management device can communicate with the management system to report status information for information handling system 500, to receive BIOS/UEFI or system firmware updates, or to perform other task for managing and controlling the operation of information handling system 500.

Management device 590 can operate off of a separate power plane from the components of the host environment so that the management device receives power to manage information handling system 500 when the information handling system is otherwise shut down. An example of management device 590 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 590 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system, comprising:
a memory including an intrusion detection service module, an intrusion scan service module, or a combination thereof; and
a processor operably coupled to the memory, the processor to:
determine whether an intrusion into the information handling system occurred using the intrusion detection service module; and
poll one or more hardware components, applications, security settings, or a combination thereof, when an intrusion is detected using the intrusion scan service module.

2. The information handling system of claim 1, the processor further to:
determine whether any changes to the hardware components, applications, security settings, or combination thereof have occurred.

3. The information handling system of claim 2, the processor further to:
allow normal operation when no changes have occurred.

4. The information handling system of claim 2, the processor further to:
when a change is detected, determine whether the change is authorized.

5. The information handling system of claim 4, the processor further to:
confirm the change, when the change is authorized; and
allow normal operation.

6. The information handling system of claim 4, the processor further to:
block one or more boot resources, when the change is not authorized.

7. The information handling system of claim 6, the processor further to:
determine whether an unauthorized change is trusted.

8. The information handling system of claim 7, the processor further to:
unblock the one or more boot resources, when the unauthorized change is trusted.

9. The information handling system of claim 7, the processor further to:
continuing to block the one or more boot resources, when the unauthorized change is untrusted.

10. A method of protecting firmware interfaces in an information handling system, the method comprising:
determining whether an intrusion into the information handling system occurred while the information handling system was in a sleep mode or a power off mode;
polling one or more hardware components, applications, security settings, or a combination thereof, when an intrusion is detected; and
determining whether any changes to the hardware components, applications, security settings, or combination thereof have occurred.

11. The method of claim 10, further comprising:
allowing normal operation when no changes have occurred.

12. The method of claim 10, further comprising:
when a change is detected, determining whether the change is authorized.

13. The method of claim 12, further comprising:
when the change is authorized, confirming the change; and
allowing normal operation.

14. The method of claim 12, further comprising:
when the change is not authorized, blocking one or more boot resources.

15. The method of claim 14, further comprising:
determining whether an unauthorized change is trusted.

16. The method of claim 15, further comprising:
when the unauthorized change is trusted, unblocking the one or more boot resources.

17. The method of claim 15, further comprising:
when the unauthorized change is untrusted, continuing to block the one or more boot resources.

18. An information handling system, comprising:
a first memory having an embedded controller stored thereon, the embedded controller including an intrusion detection service module;
a second memory having a basic input output system (BIOS) stored thereon, the BIOS including an intrusion scan service module; and
a processor operably coupled to the first memory and the second memory, the processor to:
determine whether an intrusion into the information handling system occurred using the intrusion detection service module;
poll one or more hardware components, applications, security settings, or a combination thereof, using intrusion scan service module, when an intrusion is detected; and
determine whether any changes to the hardware components, applications, security settings, or combination thereof have occurred.

19. The information handling system of claim 18, the processor further to:
allow normal operation when no changes have occurred.

20. The information handling system of claim 19, the processor further to:
determine whether the changes are authorized, when a change is detected;
confirm the change, when the change is authorized; and
allow normal operation.
